(19) United States
(12) Patent Application Publication
(10) Pub. No.: US 2012/0249597 A1
(43) Pub. Date: Oct. 4, 2012

(54) DISPLAY CONTROL APPARATUS AND COMPUTER-READABLE RECORDING MEDIUM

(75) Inventor: Hideki YOSHIDA, Tachikawa-shi (JP)

(73) Assignee: KABUSHIKI KAISHA TOSHIBA, Tokyo (JP)

(21) Appl. No.: 13/323,312

(22) Filed: Dec. 12, 2011

(30) Foreign Application Priority Data
Mar. 30, 2011 (JP) 2011-076422

(51) Int. Cl. G09G 5/00

(52) U.S. Cl. 345/660

(57) ABSTRACT

A display control apparatus includes a display module, a virtual desktop module, a determining module, and a control module. The display module displays a first image having a first size. The virtual desktop module sets, as the first image to be displayed by the display module, a partial region of a second image having a second size that is larger than the first size. The determining module allows a user to determine a region of the second image to be set as the first image by the virtual desktop module. The control module controls the virtual desktop module to change the determined region so that an undisplayed part of an object that exists in the determined region is displayed or the whole of the object is undisplayed where the object has the undisplayed part.

### CROSS REFERENCE TO RELATED APPLICATION(S)

The present disclosure relates to the subject matters contained in Japanese Patent Application No. 2011-076422 filed on Mar. 30, 2011, which are incorporated herein by reference in its entirety.

### FIELD

An exemplary embodiment of the present invention relates to a display control apparatus which controls display of an image and a computer-readable recording medium storing a display control program which controls display of an image.

### BACKGROUND

In recent years, display control apparatus having a display screen such as personal computers and portable information terminals employ user interfaces in which icons and windows are displayed on a display screen. A screen that is used as a user interface is called a desktop. A background image called a wall paper is displayed in the desktop as a background of icons and windows so as to be independent of them.

A virtual desktop technique is known in which a range that is wider than a display screen is defined as a virtual desktop. In the virtual desktop technique, a partial region of a background image having a larger size than a display screen is displayed on the display screen. The user of an information processing apparatus can move the partial region of the background image to be displayed on the display screen. That is, an arbitrary region of the background image having a larger size than the display screen is displayed on the display screen. Another technique is disclosed in which a virtual desktop is used and a range, to be displayed on a display screen, of an image is corrected.

However, a part of an image having a larger size than a display screen may be displayed in such a manner that an object in the image crosses a periphery of the display screen. In other words, when part of an image having a larger size than a display screen is displayed on the display screen, part of an object in the image may be cut away, that is, the part may not be displayed on the display screen.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a block diagram showing the system configuration of a slate personal computer (slate PC) which is a display control apparatus according to an exemplary embodiment.

FIG. 2 is a block diagram showing the functional configuration of an image display application program which is run by the slate PC.

FIG. 3 shows specific examples of position information stored in an object region information storage module.

FIG. 4 shows specific examples of range information and position information used in a virtual desktop function of the slate PC according to the embodiment.

FIG. 5 is a schematic diagram showing a state before a change of a display range by the virtual desktop function of the slate PC according to the embodiment.

FIG. 6 is a schematic diagram showing a state after execution of a first specific example operation for changing the display range.

FIG. 7 is a schematic diagram showing a state after execution of a second specific example operation for changing the display range.

FIGS. 8A and 8B are schematic diagrams showing how the display range is changed from the state shown in FIG. 5 to the state shown in FIG. 7.

### DETAILED DESCRIPTION OF THE EMBODIMENTS

According to an exemplary embodiment of the invention, there is provided a display control apparatus including a display module, a virtual desktop module, a determining module, and a control module. The display module is configured to display a first image having a first size. The virtual desktop module is configured to set, as the first image to be displayed by the display module, a partial region of a second image having a second size that is larger than the first size. The determining module is configured to allow a user to determine a region of the second image to be set as the first image by the virtual desktop module. The control module is configured to control the virtual desktop module to change the determined region so that an undisplayed part of an object that exists in the determined region is displayed or the whole of the object is undisplayed where the object has the undisplayed part.

An exemplary embodiment will be hereinafter described with reference to the drawings.

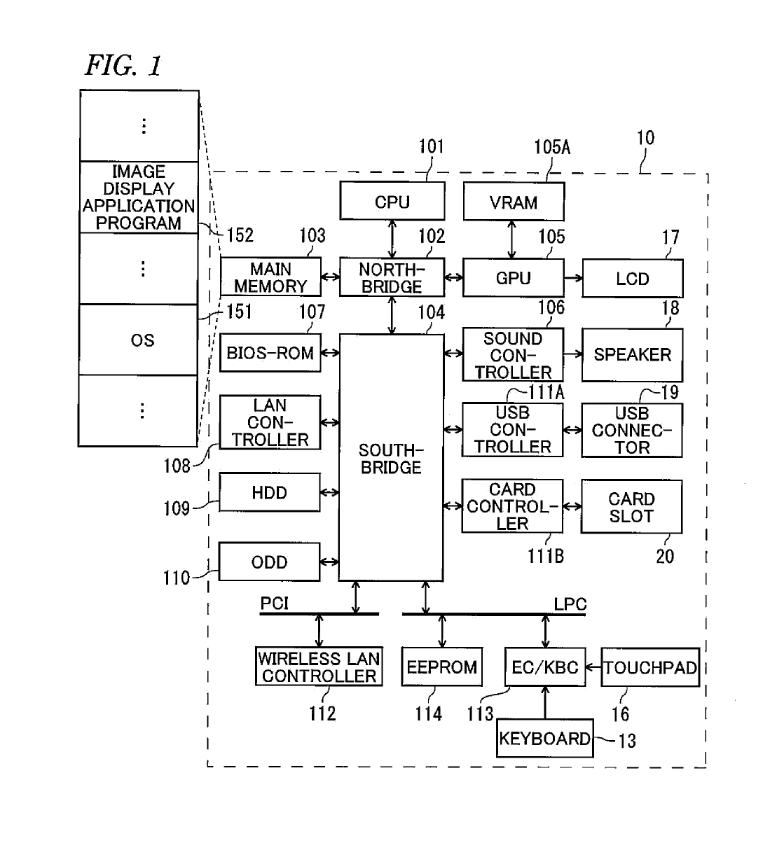

FIG. 1 is a block diagram showing the system configuration of a slate personal computer (hereinafter referred to as a slate PC) 10 which is a display control apparatus according to the embodiment.

The slate PC 10 is equipped with a CPU (central processing unit) 101, a northbridge 102, a main memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD) 109, an optical disc drive (ODD) 110, a USB controller 111A, a card controller 111B, a wireless LAN controller 112, an embedded controller/keyboard controller (EC/KBC) 113, an EEPROM (electrically erasable programmable ROM) 114, etc.

The CPU 101 is a processor which controls operations of individual components of the slate PC 10. The CPU 101 runs a BIOS which is stored in the BIOS-ROM 107. The BIOS is programs for hardware control. The CPU 101 also runs plural programs loaded into the main memory 103 from the HDD 109, such as an operating system (OS) 151 and an image display application program 152. The main memory 103 is an SRAM, for example. The image display application program 152 may be either a program as part of the OS 151 or a program that runs independently.

The image display application program 152 is software for performing a control of displaying, as a background image of a desktop, an image that is based on still image data stored in the HDD 109, for example. The desktop is a picture that is used as a user interface in which icons and windows are displayed on a display screen. The image display application program 152 controls a virtual desktop having a larger size than the display screen. In a virtual desktop technique or function, part of an image having a larger size than a display screen is displayed on the display screen as a desktop. The virtual desktop function according to the embodiment allows the user of the slate PC 10 to determine a region of an image having a larger size than the display screen to be displayed on the display screen. A display range of a background image is set properly according to the position of an object, to be displayed on the display screen, in the background image.

The northbridge 102 is abridge device which connects a local bus of the CPU 101 to the southbridge 104. The northbridge 102 incorporates a memory controller for access-controlling the main memory 103. The northbridge 102 also has a function of performing a communication with the GPU 105 via, for example, a serial bus that complies with the PCI Express standard.

The GPU 105 is a display controller which controls an LCD 17 which is used as a display monitor of the slate PC 10. The GPU 105 generates a display signal, which is sent to the LCD 17. The LCD 17 displays an image on the display screen on the basis of the display signal sent from the GPU 105.

The southbridge 104 controls the individual devices on a PCI (peripheral component interconnect) bus and the individual devices on an LPC (low pin count) bus. The southbridge 104 incorporates an IDE (integrated drive electronics) controller for controlling the HDD 109 and the ODD 110. The southbridge 104 also has a function of controlling a communication with the sound controller 106.

The sound controller 106, which is a sound source device, outputs reproduction subject audio data to a speaker 18. The LAN controller 108 is a wired communication device which performs a wired communication according to the IEEE 802.3 standard, for example. On the other hand, the wireless LAN controller 112 is a wireless communication device which performs a wireless communication according to the IEEE 802.11g standard, for example. The USB controller 111A performs a communication with an external device (connected to a USB connector 19) which complies with the USB 2.0 standard, for example. The card controller 111B writes and reads data to and from a memory card such as an SD card that is inserted in a card slot 20 that is formed in the main body of the slate PC.

The EC/KBC 113 is a one-chip microcomputer in which an embedded controller for power management and a keyboard controller for controlling the keyboard 13 and the touchpad are integrated together. The touchpad 16 may be integrated with the LCD 17. The EC/KBC 113 receives a manipulation input from a mouse (not shown) as well as the keyboard 13 and the touchpad 16. The EC/KBC 113 has a function of powering on/off the slate PC 10 in response to a manipulation of a power button (not shown).

Still image data of a background image of the virtual desktop function maybe stored in a nonvolatile memory other than the HDD 109. This nonvolatile memory may be provided outside the slate PC 10, and may be connected to the slate PC 10 via the USB connector 19 or the card slot 20. Still image data maybe acquired from a storage module on a network that is connected to the slate PC 10 via the LAN controller 108 or the wireless LAN controller 112.

Still image data of a background image of the virtual desktop function may be of an image that is larger than the display screen in both of the vertical direction and the horizontal direction or of an image that is larger than the display screen in the vertical direction or the horizontal direction.

With the above configuration, the slate PC 10 can display, on the LCD 17, as a desktop, image data stored in the HDD 109 by running the image display application program 152. Since the virtual desktop function is realized by the image display application program 152, part of an image having a larger size than the display screen of the LCD 17 can be displayed on the LCD 17. In the virtual desktop function according to the embodiment, a display range of a background image on the LCD 17 is set properly according to the position of an object in the background image.

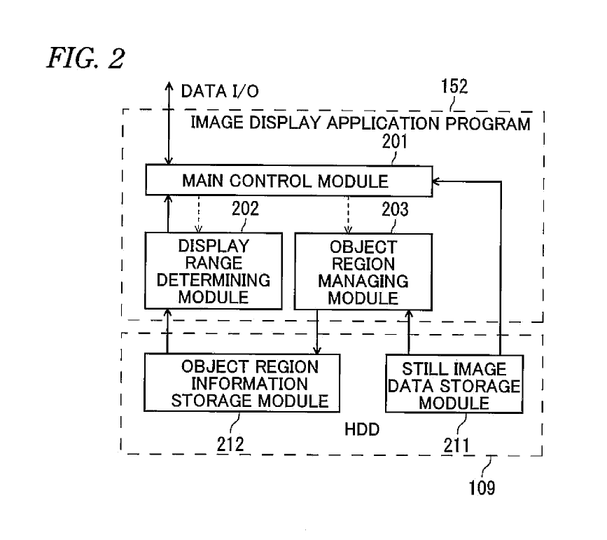

Next, the functional configuration of the image display application program 152 which runs on the slate PC 10 will be described with reference to FIG. 2.

FIG. 2 is a block diagram showing the functional configuration of the image display application program 152 which is run by the slate PC 10.

As described above, the image display application program 152 according to the embodiment realizes the virtual desktop function which sets a display range of a background image on the display screen according to the position of an object in the background image. For example, a characteristic portion of a background image such as the face or the entire body of a person or an animal or a character string can be an object of the background image.

The image display application program 152 is provided with a main control module 201, a display range determining module 202, and an object region managing module 203. The HDD 109 is provided with a still image data storage module 211 and an object region information storage module 212.

The main control module 201 receives start information which indicates a start of operation of the virtual desktop function. Upon the reception of the start information, the main control module 201 outputs, to each of the display range determining module 202 and the object region managing module 203, instruction information for instructing it to perform prescribed processing. Upon the reception of the start information, the main control module 201 reads still image data from the still image data storage module 211. Furthermore, the main control module 201 outputs image data that is part of the read-out still image data and is to be displayed on the display screen, to the LCD 17 according to range information received from the display range determining module 202. The range information is information relating to a display range of an image having a larger size than the display screen.

Based on the instruction information received from the main control module 201, the display range determining module 202 reads, from the object region information storage module 212, position information relating to the position of an object in the entire image. The display range determining module 202 determines a display range of the image on the display screen on the basis of the read-out position information. In the embodiment, a display range is determined so that an object is displayed on the display screen properly with respect to the entire image. The display range determining module 202 outputs range information corresponding to the determined display range to the main control module 201.

The object region managing module 203 reads still image data from the still image data storage module 211, and determines pieces of position information of objects to exist in images to be generated from the read-out still image data. The object region managing module 203 stores the determined pieces of position information in the object region information storage module 212 in such a manner that they are correlated with the respective objects to exist in the images.

The still image data storage module 211 stores still image data of images having larger sizes than the display screen and to be used in virtual desktop control. Further, the still image data storage module 211 stores still image data of images to be background images in a desktop.

The object region information storage module 212 stores pieces of position information in such a manner that they are correlated with respective objects. The position information is information configured to uniquely determine the position of an object with respect to the entire image. The position information is stored so as to be correlated with still image data. That is, not only the object but also the still image data can be determined from the position information.

The still image data storage module 211 and the object region information storage module 212 maybe provided in a storage module other than the HDD 109. This storage module need not always be provided inside the slate PC 10, and may be connected to the slate PC 10 via the USB connector 19, the card slot 20, the LAN controller 108, or the wireless LAN controller 112. The object region information storage module 212 may be provided in a primary storage such as the main memory 103 rather than a secondary storage such as the HDD 109.

Position information of an object to exist in an image to be generated from still image data may be determined by the user of the slate PC 10 using an edit program. The edit program is an application program which allows the user of the slate PC 10 to set a range of an object in an image on the display screen using the keyboard 13, the touchpad 16, or the like. Position information corresponding to a range, set in this manner, of an object is stored in the object region managing module 203. Alternatively, the object region managing module 203 may extract an object such as a face or a character string in a subject image by analyzing the image using a known image analysis technique.

In other words, the object region managing module 203 may identify a region of an object from a subject image by analyzing the image based on a feature of the object and generate position information of the identified region. Position information of an object may be determined using both of the edit program and the known image analysis technique.

The display range determining module 202 and the object region managing module 203 may run as independent programs instead of being provided in the image display application program 152.

The image display application program 152 according to the embodiment may be a program that is recorded in a readable recording medium rather than software that is stored inside the slate PC 10. Or the image display application program 152 may be a program that is run in a Web site on a network.

With the above configuration, the image display application program 152 can realize the virtual desktop function. In the virtual desktop function according to the embodiment, a display range of a background image on the display screen is set according to the position of an object. Therefore, in the slate PC 10 according to the embodiment, when part of an image having a larger size than the display screen is displayed on the display screen, how an object is displayed on the display screen with respect to the entire image can be controlled properly.

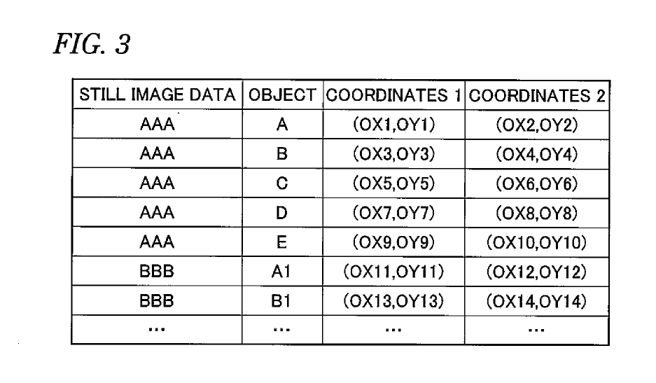

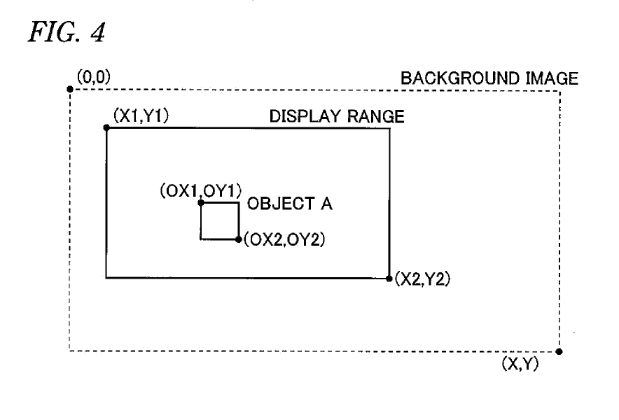

Next, specific examples of range information and position information used in the virtual desktop function of the slate PC 10 according to the embodiment will be described with reference to FIGS. 3 and 4. FIG. 3 is specific examples of position information stored in the object region information storage module 212. FIG. 4 shows specific examples of range information and position information used in the virtual desktop function of the slate PC 10 according to the embodiment.

In the virtual desktop function of the slate PC 10 according to the embodiment, each of range information and position information is managed in the form of sets of coordinates. More specifically, each of range information and position information is managed in the form of sets of coordinates of an coordinate system defined for a background image of the virtual desktop function. The position information of an object is managed as a range that is enclosed by a rectangle, an ellipse, a circle, a polygon, or a closed curve. The following description will be directed to a case that the position information of an object is managed as a range that is enclosed by a rectangle.

As shown in FIG. 3, the position information of each object is stored as two sets of an X coordinate and a Y coordinate. One of the two sets of an X coordinate and a Y coordinate is coordinates of the top-left corner point, on the display screen, of an object and the other set is coordinates of its bottom-right corner point. Using such two sets of an X coordinate and a Y coordinate, each object can be defined as a range enclosed by a rectangle in the background image. Each object is stored so as to be correlated with the still image data where it exists.

FIG. 4 shows a state that a display range corresponding in size to the display screen is part of a background image of the virtual desktop function and an object A exists in a region that is located inside the display range. In this state, each of the display range and the region where the object A exists is managed in the form of sets of coordinates. More specifically, the background image is managed using coordinates (0, 0) (origin) of its top-left point (as viewed in FIG. 3) and coordinates (X, Y) of its bottom-right point. The display range is managed using coordinates (X1, Y1) of its top-left point and coordinates (X2, Y2) of its bottom-right point. The region of the object A is managed using coordinates (OX1 , OY1) of its top-left point and coordinates (OX2, OY2) of its bottom-right point. The X coordinates have a magnitude relationship 0<X1<OX1<OX2<X2<X and the Y coordinates have a magnitude relationship 0<Y1<OY1<OY2<Y2<Y.

The display range may be managed using the coordinates (X1, Y1) of the top-left point (only one point) as long as the size of the display screen is not changed. Shift lengths (X2-X1, Y2-Y1) corresponding to the size of the display screen are stored independently, which makes it possible to identify the display range by adding the shift lengths to the coordinates (X1, Y1) of its top-left point, respectively. Alternatively, the display range may be lo managed using the coordinates (X2, Y2) of the bottom-right point (only one point). In this case, the display range can be identified by subtracting the shift lengths from the coordinates (X2, Y2) of its bottom-right point, respectively. On the other hand, where the size of the display screen may be changed, as described first the display range needs to be managed in the form of sets of coordinates of its top-left point and bottom-right points (two points). Where the size of the display screen is not changed as in the case of the slate PC 10, the display range may be managed in the form of the coordinates of the top-left point or the bottom-right point.

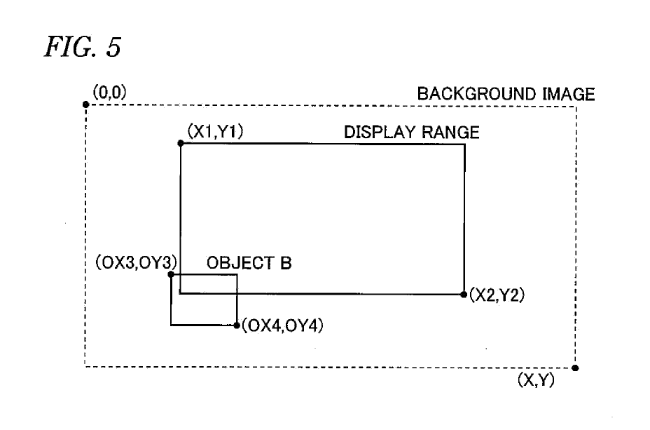

Next, specific example operations of the virtual desktop function of the slate PC 10 according to the embodiment will be described with reference to FIG. 5 to FIG. 8B.

FIG. 5 is a schematic diagram showing a state before a change of the display range by the virtual desktop function of the slate PC 10 according to the embodiment.

As described above, the image display application program 152 according to the embodiment realizes the virtual desktop function in which the display range of a background image on the display screen is set according to the position of an object in the background image. In the virtual desktop function, still image data of a background image is read out upon occurrence of an event such as a start of execution of the virtual desktop function, a change of the background image of the virtual desktop, or a change of the display range with respect to the entire background image. The background image display range is set or changed upon occurrence of such an event.

As described above, the virtual desktop function according to the embodiment allows the user of the slate PC 10 to determine what region of a background image should be displayed on the display screen. In other words, the user of the slate PC 10 can perform a manipulation of changing, in a selective manner, the display range with respect to the entire background image using an input means such as the keyboard 13, the touchpad 16, or the mouse (not shown). The display range is changed in such a manner that the sets of coordinates representing the display range are changed in units of a minimum unit of the coordinate system for the background image, a minimum unit of the abscissa or ordinate of the display screen, or a value obtained by dividing the minimum unit of the abscissa or ordinate of the display screen. Which kind of unit should be used in changing the display range may be determined depending on which input means is used.

### (Specific Example Operation Performed Before Change of Display Range)

Manipulations for setting or changing the display range of a background image may be completed in a state that an object existing in the display range crosses the periphery of the display range. FIG. 5 shows such a state schematically. More specifically, FIG. 5 shows a state that the top-left point and the bottom-right point of the display range are managed using (X1, Y1) and (X2, Y2), respectively, and those of an object B are managed using (OX3, OY3) and (OX4, OY4), respectively.

Upon completion of manipulations for setting or changing a display range, a positional relationship between the display range and an object is judged. This can be done by the display range determining module 202 by comparing the sets of coordinates of the display range with those of the object. In the state shown in FIG. 5, first, a positional relationship between the object B and a left-hand periphery (as viewed in FIG. 5) of the display range is judged. More specifically, the X coordinate OX3 of the top-left point and the X coordinate OX4 of the bottom-right coordinate of the object B and the X coordinate X1 of the top-left point of the display range are compared with each other. The X coordinates have a magnitude relationship OX3<X1<OX4. Based on this magnitude relationship, it is judged that object B crosses the left-hand periphery of the display range.

Then, a positional relationship between the object B and a top periphery (as viewed in FIG. 5) of the display range is judged. More specifically, the Y coordinate OX3 of the top-left point and the Y coordinate OY4 of the bottom-right coordinate of the object B and the Y coordinate Y1 of the top-left point of the display range are compared with each other. The Y coordinates have a magnitude relationship Y1<OY3<OY4. Based on this magnitude relationship, it is judged that object B is located below the top periphery of the display range. Similar judgments are made of a right-hand periphery and a bottom periphery of the display range. The resulting coordinate magnitude relationships for the four peripheral lines of the display range lead to a judgment that the object B crosses the left-hand periphery and the bottom periphery of the display range.

### (First Specific Example Operation for Changing Display Range)

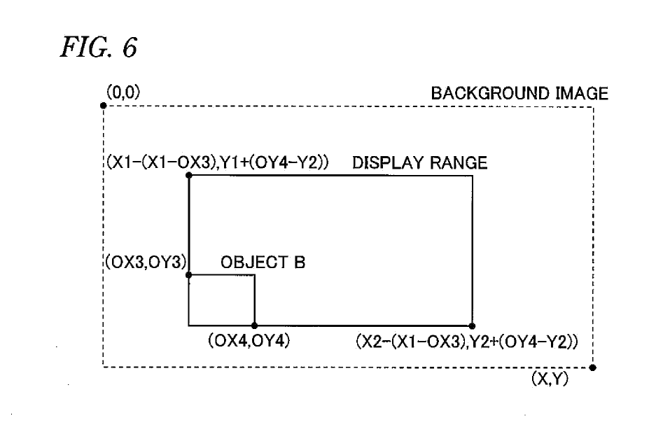

FIG. 6 is a schematic diagram showing a state after execution of a first specific example operation for changing the display range.

If as shown in FIG. 5 only one object exists in the display range, the display range is changed (moved) so that the entire object is displayed in the display range.

In the state of FIG. 5, the judgment result has been obtained that the object B sticks out of the display range leftward by X1-OX3 and downward by OY4-Y2. In this case, the entire object B can be displayed in the display range by moving the display range leftward by X1-OX3 and downward by OY4-Y2.

The sets of coordinates of the display range are changed so that the coordinates of the top-left point of the display range are changed from (X1, Y1) to (X1-(X1-OX3), Y1-(OY4-Y2)) and the coordinates of the bottom-right point are changed from (X2, Y2) to (X2-(X1-OX3), Y2-(OY4-Y2)). More specifically, in the example of FIG. 6, the display range is managed using the coordinates (X1-(X1-OX3), Y1-(OY4-Y2)) of its top-left point and the coordinates (X2-(X1-OX3), Y2-(OY4-Y2)) of its bottom-right point. On the other hand, the object B is managed using the coordinates (OX3, OY3) of its top-left point and the coordinates (OX4, OY4) of its bottom-right point, that is, in the same manner as in the state of FIG. 5.

### (Second Specific Example Operation for Changing Display Range)

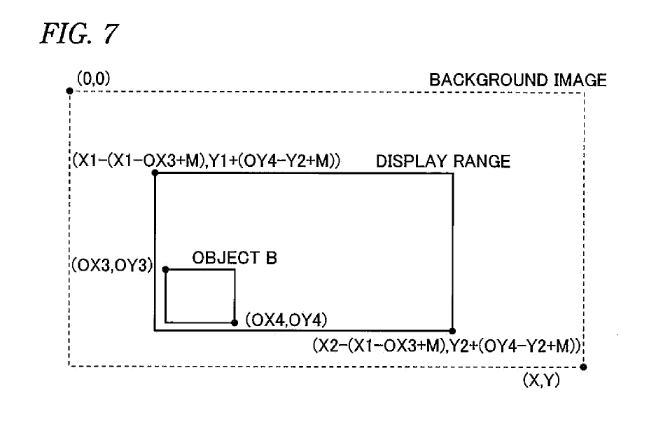

FIG. 7 is a schematic diagram showing a state after execution of a second specific example operation for changing the display range.

Whereas in the first specific example operation for changing the display range (see FIG. 6) the object comes to be displayed so as to be approximately adjacent to the left-hand periphery and the bottom periphery of the display range, in the second specific example operation the display range comes to be displayed so as to be separated inward from the left-hand periphery and the bottom periphery of the display range by a prescribed length.

In the state of FIG. 5, the judgment result has been obtained that the object B sticks out of the display range leftward by X1-OX3 and downward by OY4-Y2. In this case, the entire object B can be displayed in the display range by moving the display range leftward by X1-OX3 and downward by OY4-Y2. In the second specific example operation, the display range is changed so that the object B is separated inward from the related peripheral lines of the display range by a prescribed length M. More specifically, the object B can be separated inward from the related peripheral lines of the display range by the prescribed length M by moving the display range leftward by X1-OX3+M and downward by OY4-Y2+M.

The sets of coordinates of the display range are changed so that the coordinates of the top-left point of the display range are changed from (X1, Y1) to (X1−(X1−OX3+M), Y1−(OY4−Y2+M)) and the coordinates of the bottom-right point are changed from (X2, Y2) to (X2−(X1−OX3+M), Y2−(OY4−Y2+M)). More specifically, in the example of FIG. 7, the display range is managed using the coordinates (X1−(X1−OX3+M), Y1−(OY4−Y2+M)) of its top-left point and the coordinates (X2−(X1−OX3+M), Y2−(OY4−Y2+M)) of its bottom-right point. On the other hand, the object B is managed using the coordinates (OX3, OY3) of its top-left point and the coordinates (OX4, OY4) of its bottom-right point, that is, in the same manner as in the states shown in FIGS. 5 and 6.

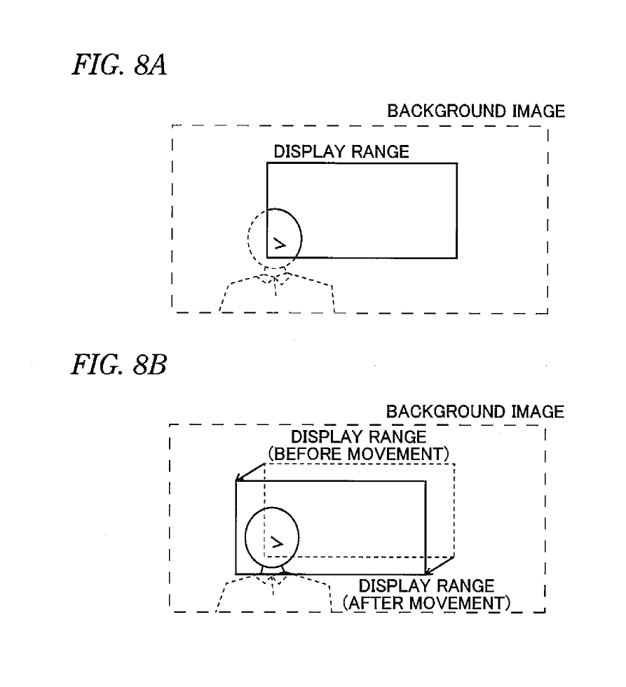

FIGS. 8A and 8B schematically show how the display range is changed by the virtual desktop function according to the embodiment from the state of FIG. 5 to the state of FIG. 7. FIG. 8A shows a state before a change of the display range in which a human face as an object located at a bottom-left position on the display screen crosses the periphery of the display range. FIG. 8B shows a state after the change of the display range in which the human face as the object is displayed inside the display range in its entirety.

In the specific operation examples of FIGS. 6 and 7, the display range is changed so that the object that crosses the periphery of the display range comes to be displayed inside the display range in its entirety. However, the display range may be changed so that the object that crosses the periphery of the display range comes to be located outside the display range in its entirety and hence comes not to be displayed at all. Whether the display range should be changed so that the object comes to be located inside or outside the display range in its entirety may be determined according to a result of a judgment as to which manner of changing the display range causes a lower degree of change in the display range. Since the display range is changed by selecting one, causing a lower degree of change in the display range, of the two candidates, in different directions, for the manner of changing the display range, an event that the display range is changed to a large extent can be avoided.

In the virtual desktop function, not only an image that is part of a background image having a larger size than the display screen but also icons and an application window are displayed on the display screen. The specific example operations of FIGS. 6 and 7 are directed to the case that only the display range is changed for the entire background image. However, the positions of icons and an application window may be changed for the entire background image together with the display range. Where the positions of icons and an application window are changed together with the display range, the positional relationships between the object and the icons or the application window can be maintained.

Although the specific example operations of FIGS. 6 and 7 are directed to the case that the only one object exists in the display range at least partially, there may occur a case that plural objects exist in the display range at least partially. However, it may be impossible to display all of those objects inside the display range in their entireties. In such a case, which objects should be displayed preferentially may be determined by giving pieces of priority information to the plural respective objects that exist in the display range at least partially. Alternatively, which of the plural objects should be selected as objects to be changed may be judged by evaluating a function whose value is proportional to the number of objects displayed. As a further alternative, ones with shorter movement lengths may be selected as objects to be changed from the plural objects.

In the virtual desktop function according to the embodiment, a positional relationship between a display range and an object is judged upon completion of manipulations for setting or changing the display range. The display range is changed according to a judgment result so that the entire object is displayed inside the display range. That is, in the slate PC 10 according to the embodiment, when part of an image having a larger size than a display screen is displayed on the display screen, how an object is displayed on the display screen with respect to the entire image can be controlled properly.

As described above, according to the embodiment, part of an image having a larger size than a display screen is displayed as a desktop in a display range on the display screen on the basis of stored image data. The virtual desktop function sets the display range according to the position of an object in the background image. Therefore, in the slate PC 10 according to the embodiment, when part of an image having a larger size than a display screen is displayed on the display screen, how an object is displayed on the display screen with respect to the entire image can be controlled properly.

Although the embodiment has been described above, the embodiment is just an example and should not be construed as restricting the scope of the invention. And various changes, alterations, etc. may be made in the embodiment without departing from the spirit and scope of the invention. Furthermore, various inventive concepts may be conceived by properly combining plural constituent elements disclosed in the embodiment. For example, several ones of the constituent elements of the embodiment may be omitted. These modifications are also included in the invention as claimed and its equivalents.

What is claimed is:

1. A display control apparatus comprising:
a display module configured to display a first image having a first size;
a virtual desktop module configured to set, as the first image, a partial region of a second image having a second size that is larger than the first size;
a determining module configured to receive an indication from a user of a region of the second image to be set as the first image by the virtual desktop module; and
a control module configured to cause the virtual desktop module to change the determined region so that an undisplayed part of an object in the determined region is displayed or the whole of the object is undisplayed.

2. The display control apparatus of claim 1, wherein the object comprises a face of a person or an animal or the object comprises a character string.

3. The display control apparatus of claim 2, wherein the control module is configured to determine the undisplayed part based on position information in a coordinate system defined for the second image, the position information indicating a region where the object exists and a set or sets of coordinates, in the coordinate system, indicating a range of the first image.

4. The display control apparatus of claim 3, further comprising a setting module configured to allow the user to set the position information of the object existing in the first image being displayed by the display module.

5. The display control apparatus of claim 3, further comprising a generating module configured to identify a region comprising the object based on a feature of the object in a state that the first image is displayed by the display module, and to generate position information of the identified region.

6. A non-transitory computer-readable recording medium configured to store a display control program, the program configured to cause a display control apparatus to perform the method comprising:
setting, as a first image to be displayed, the first image having a first size, a partial region of a second image having a second size that is larger than the first size;
allowing a user to determine a region of the second image to be set as the first image; and
performing a control so that an undisplayed part of an object in the determined region is displayed or the whole of the object is undisplayed
